(19) United States
(12) Patent Application Publication
(10) Pub. No.: US 2015/0289500 A1
(43) Pub. Date: Oct. 15, 2015

(54) CRYOGENIC STORAGE DEVICE AND METHOD FOR OPERATING SAME

(71) Applicant: FRAUNHOFER-GESELLSCHAFT ZUR FÖRDERUNG DER ANGEWANDTEN FORSCHUNG E.V., München (DE)

(72) Inventors: Guenter R. Fuhr, Berlin (DE); Heiko Zimmermann, Waldbrunn (DE)

(21) Appl. No.: 14/439,226

(22) PCT Filed: Dec. 4, 2013
(86) PCT No.: PCT/EP2013/003664

§ 371 Date: Apr. 28, 2015

(30) Foreign Application Priority Data
Dec. 10, 2012 (DE) 10 2012 024 105.4

(51) Int. Cl. A01N 1/02

(52) U.S. Cl. CPC A01N 1/0252

(57) ABSTRACT

The invention relates to a cryogenic storage device (100), in particular for storing biological samples (1) in the cryopreserved state, comprising a storage container (cryogenic tank 10) for cooling the samples in a reservoir (12) of liquid nitrogen or in a nitrogen vapour above the reservoir, a hood (21), and a flushing device (30) for introduction of a coolant (preferably cold nitrogen gas) into the hood space (22). The storage container is closed by a lid section (13). The coolant conduit (31) of the flushing device opens in the hood space (22). The storage temperature is adjustable in a locally delimited cooling section (24) by the refrigerant stream (2). The flushing device comprises a coolant vessel (32), which is formed by the storage container (10) with the reservoir of liquid nitrogen and/or an additional container. The invention further relates to a method for operating the cryogenic storage device.

The invention relates to a cryogenic storage device, in particular for storing samples in a cryopreserved state, comprising a storage container for accommodating and cooling the samples, a hood device which forms a hood space adjoining the storage container, and a sample carrier which is provided for temporarily holding samples in the hood space. The invention also relates to a method for handling samples in the cryopreserved state using a cryogenic storage device comprising a storage container and a hood device.

Due to the increasing use of cryostores (or cryobanks), particularly for depositing living cell material, with sample numbers ranging from a few tens of thousands to a few million, there is increasing interest in an automation of procedures for operating the cryobanks. The aim of the automation is to achieve cost-effective storage conditions. The automation is also intended to enable an improved implementation of SOP conditions (SOP: Standard Operating Procedures), to enable documentation that is as complete as possible, and to make it possible to minimize operating errors, as required in the biomedical field.

The automation of cryobanks with cooling by liquid nitrogen (LN₂) in tanks at storage temperatures considerably below −100° C. has until now been made difficult by the following problems:
Ice accumulation on samples, movable parts such as joints, guides, etc., or electric contact surfaces due to condensing and freezing moisture from the air upon multiple opening of the tanks, as is unavoidable in cryobanks.
Ice accumulation on the sample surface when said samples are brought into ambient air having a normal moisture content (30 to 90%).
Heating of the samples, with increasing miniaturization, when said samples are removed from the deep-frozen LN₂ atmosphere. This is particularly critical in the case of tubular sample containers (so-called straws) and sample volumes of less than 0.5 ml.
Contamination of the sample vessel surface when said vessels are transferred to a non-sterile environment.

Said problems, which occur individually or in combination in conventional cryobanks depending on the design of the latter, have until now been a critical obstacle to automated sample management, including moving samples into and out of storage, that is robust over the long term. Improvements have been achieved only by using hood devices which are mounted above tanks or storage containers in which cryosamples are stored, see for example DE 10 2011 012 887 A1, US 2007/169 488 A1 (EP 1 768 782 A1) or US 2006/156 753 A1 (WO 2005/010499 A2). The hoods, which for example are flooded with dry nitrogen gas and completely cooled prior to opening the storage container, can be used as locks for sample handling.

Another cryogenic storage device having a completely cooled hood above the storage container is also described in US 2011/0219788 A1 (DE 10 2008 057 981 A1). Running in the interior of the hood is a conduit with exit holes which form a cooling gas inlet. The exit holes are arranged in a distributed manner so that nitrogen gas, which flows out into the interior of the hood, evenly cools said hood. U.S. Pat. No. 5,233,844 A (DE 692 30 405 T2) also discloses a cooling container having a hood-like attachment, the interior of which can be acted upon by coolant vapor and can accordingly be completely cooled.

In practice, however, the use of hoods above storage containers has proven to be disadvantageous due to the following problems. The cooling of a hood, with the increasing size thereof, to temperatures below −80° C. leads to a high coolant outlay and to a process delay in the range of, for example, 10 to 30 minutes. These problems intensify even further when it is desired to cool the hood down to the storage temperature in the storage container, for example −150° C. Removing or inserting samples multiple times considerably increases the LN₂ consumption. If the temperature in the hood is to be kept at a reduced level for a relatively long period of time, this requires good thermal insulation and leads to a compact, space-consuming design of the hood device, which has an adverse effect on costs and handling ability. Moreover, the discharging of the gas volume in the hood and the flooding with dry cold nitrogen must be carried out very carefully in order to avoid turbulence and to prevent moist air from entering the hood, which could result in local ice accumulations.

Furthermore, it is known from practice that the quality of a biological sample comprising frozen living cells decreases if the sample is exposed to multiple temperature changes from the storage temperature (for example −150° C.) to −80° C. However, such heating and cooling down again occurs very frequently during the operation of cryobanks since, in order to remove a few samples, whole sample racks comprising hundreds of cryotubes, straws or pouches are pulled into warmer areas, for example under the hood. Undesired temperature changes may also occur when refilling the LN₂.

Therefore, particularly in the case of long-term storage, the aim is to keep the storage temperature as constant as possible, which in the case of conventional hood devices is associated with an excessive coolant consumption and/or a need for extremely high thermal insulation.

The objective of the invention is to provide an improved cryogenic storage device, by which disadvantages of conventional techniques are avoided. The objective of the invention is in particular to minimize, with the lowest possible technical effort, the heating of a sample when removing from or placing into storage, the accumulation of ice and/or the contamination of the sample container surface, to minimize or to avoid the LN₂ consumption, particularly for hood cooling, and/or to allow small hood devices that are as lightweight as possible while having a reduced vulnerability to low temperatures. The objective of the invention is also to provide an improved method for operating a cryogenic storage device, by which disadvantages of conventional techniques are avoided.

These objectives are achieved respectively by a cryogenic storage device and a method for operating same having the features of the independent claims. Advantageous embodiments and applications of the invention emerge from the dependent claims.

According to a first aspect of the invention, said objective is achieved by a cryogenic storage device which is adapted for storing samples at low temperatures, in particular for storing biological samples in a cryopreserved state. The cryogenic storage device comprises a storage container, for example a thermally insulated cryotank having an inner space which is closed off from the surrounding environment by a lid section. The inner space is adapted for accommodating liquid nitrogen, which typically forms a liquid nitrogen reservoir (so-called nitrogen lake) at the bottom of the storage container. The inner space is also adapted for accommodating the samples. To this end, for example, carrier devices (so-called “racks”) may be arranged in the inner space. The samples may be stored in the storage container directly in the reservoir of liquid nitrogen or in the nitrogen vapor which forms in the inner space above the reservoir of liquid nitrogen, in a manner cooled at a predetermined storage temperature. Preferably, the cryogenic storage device is adapted for a storage temperature of −80° C. or below, particularly preferably −150° C. or below.

The cryogenic storage device further comprises a hood device which is arranged in a manner adjoining the storage container. By virtue of the hood device, there is formed above the lid section a hood space which is delimited from the surrounding environment by the hood device. The hood space forms a lock chamber in which the samples are temporarily arranged, optionally together with part of a carrier device, prior to being introduced into the storage container or after removal from the latter. Alternatively, the hood device may optionally be equipped with a sample carrier for temporarily holding the samples.

The cryogenic storage device further comprises a flushing device having a coolant vessel, from which a coolant, such as, for example, vapor of liquid nitrogen or another cooling gas, can be transferred into the hood space. According to the invention, the flushing device is provided with at least one coolant conduit which leads from the coolant vessel into the hood space. The coolant conduit is adapted for applying the coolant to a sub-area of the hood space such that the storage temperature of the samples in the storage container can also be set in the sub-area in question. The sub-area, which will be referred to hereinafter as the cooling section, is provided for the temporary placement of samples. While the storage temperature can be set in the cooling section, a temperature gradient to higher temperatures forms in the area surrounding the cooling section in the hood space. The cooling section is not a mechanically delimited area, but rather is a spatial area in which the storage temperature can be set by the coolant flow. Thus, depending on the specific use of the invention, the size of the cooling section depends on the number and cooling capacity of the coolant conduits but in any case is smaller than the volume of the hood space. Advantageously, the flushing device having the at least one coolant conduit is designed in such a way that the storage temperature is set locally exclusively in the cooling section, but not in the rest of the hood space.

According to a second aspect of the invention, the abovementioned objective is provided by a method for handling samples in the cryopreserved state, in which the samples, following removal from an inner space of a storage container, for example a cryotank, or prior to being introduced into the inner space of the storage container, are arranged in a hood space of a hood device adjoining the storage container, in a locally delimited cooling section at the storage temperature, while the temperature in the rest of the hood space is increased relative to the cooling section. By virtue of the inventive provision of a locally delimited cooling section, the situation is advantageously achieved whereby the hood device above the storage container is cooled only slightly or to a negligibly small extent. Exclusively the sample and its immediate surroundings are exposed to a constant flow of a cold coolant stream as soon as the sample is situated in the hood space. Other parts of the hood device, in particular mechanically movable components, drives or the like, can be operated at a temperature above the storage temperature, or even up to room temperature. In contrast to conventional techniques, therefore, it is no longer necessary to provide a thermally insulated hood. Furthermore, due to the locally limited cooling of the sample in the hood space, the consumption of coolant is considerably reduced. The vulnerability of mechanical components to low temperatures is also not a problem, in contrast to conventional techniques.

Since the at least one coolant conduit is adapted for continuously applying the coolant flow to the cooling section, an undesired heating of the sample in the hood space is ruled out, as is an ice accumulation on or contamination of the sample surface. According to the invention, use may be made of compact hoods in which robotic systems, sensor systems and other components can be operated at increased temperatures, even up to room temperature.

The term “sample” denotes any article that is subjected to cryopreservation in the storage container, and includes one or more sample containers, for example tubes, straws, capsules, pouches or the like, and sample material therein, optionally in connection with part of a carrier device. The sample material typically comprises biological material, such as cells, tissue, cell components or biological macromolecules. In other words, the sample which according to the invention is kept cooled at the storage temperature in the cooling section may comprise, for example, one or more sample tubes or a carrier with one or more sample tubes. The cooling section in the hood space may accordingly have a volume that is adapted to the samples used, depending on the application, and is at least 100 cm³, for example at least 500 cm³. In the case of relatively small samples, one single coolant conduit may suffice for cooling purposes, while in the case of larger samples multiple coolant conduits are provided.

Advantageously, different variants are available for supplying the coolant to the flushing device of the cryogenic storage device according to the invention. Preferably, the coolant comprises cold nitrogen gas, in particular vapor of liquid nitrogen, which is formed at normal pressure above a reservoir of liquid nitrogen. In this case, the coolant vessel is a vessel for accommodating liquid nitrogen. With particular preference, the coolant vessel is formed by the storage container of the cryogenic storage device. Advantageously, in this case, the liquid nitrogen in the storage container may be used both for cooling the samples in the storage container and also for providing the coolant flow for cooling the cooling section in the hood space. As an alternative or in addition, there may be arranged outside of the storage container an additional container for accommodating liquid nitrogen, which forms the coolant vessel of the flushing device. Providing the additional container has advantages for constructing the cryogenic storage device according to the invention using the available components of conventional storage devices. According to an alternative variant, the coolant may comprise a gas other than nitrogen, in particular an anhydrous gas, such as, for example, oxygen, an inert gas or carbon dioxide. In this case, preferably a thermoelectric cooling of the coolant in the coolant vessel and/or in the coolant conduit is provided. This embodiment of the invention may have advantages in relation to the compactness of the cryogenic storage device and the speed at which the temperature is set in the cooling section.

In order to be able to influence the cooling effect of the flushing device in the cooling section when nitrogen vapor is used as the coolant, according to a further embodiment of the invention it is advantageous if a heating device, such as, for example, an electric resistance heater, is arranged in the storage container and/or in the additional container for accommodating liquid nitrogen. By actuating the heating device, the formation of nitrogen vapor can be assisted and thus the coolant flow to the cooling section can be increased.

If the coolant vessel is formed by the storage container (cryotank) of the cryogenic storage device according to the invention, the at least one coolant conduit preferably extends from the inner space of the storage container, through the lid section thereof, to the cooling section. An inner end of the coolant conduit is preferably located immediately above the surface of the liquid nitrogen in the storage container, while an outer end of the coolant conduit in the hood space is directed towards the cooling section, in particular towards a sample arranged therein. In order to amplify the directional effect of the coolant conduit, the latter may be equipped with a nozzle at its outer end.

According to a further variant of the invention, the hood device may be provided with a sample carrier which is arranged in the cooling section and is designed to hold samples. The sample carrier may fix for example at least one individual sample or a group of samples or part of a rack, in order for example to allow preparation for further sample handling or sample processing.

According to further advantageous embodiments of the invention, one or more of the following measures may be implemented in order to improve the locally delimited cooling effect in the cooling section, in particular on the sample carrier. According to a first measure, a deflecting device may be arranged on the cooling section, by which coolant flowing out of the coolant conduit can be directed into the cooling section. The deflecting device comprises, for example, components with curved or angled surfaces (directing elements) which guide the coolant flow between the outer end of the coolant conduit and the cooling section. Coolant is thus advantageously prevented from flowing away into the surrounding area. According to another measure, a shielding device may be provided, which extends over the cooling section. The shielding device comprises a curved area-measured component, by which falling gases in the hood space are directed away from the cooling section. During operation of the cryogenic storage device according to the invention, parts of the hood space in particular above the cooling section may be cooled. The cooling gases may fall towards the cooling section, but by virtue of the shielding device are led away to the side of the sample carrier in the cooling section so that an undesired condensation of residual moisture or a contamination on the sample is avoided. According to a further variant, the sample carrier in the cooling section may be connected to a heat sink, in particular to the inner space of the storage container, via heat-conducting elements. Samples on the sample carrier are thus advantageously brought into thermal contact with materials or heat capacity and the cooling to storage temperature is additionally aided.

Preferably, the cooling section is provided with a temperature sensor. The temperature sensor, such as, for example, a thermoelectric sensor, is provided for measuring the temperature in the cooling section, in particular on the sample carrier. Advantageously, the temperature sensor aids the automation of the cryogenic storage device. The cryogenic storage device may in particular be provided with a control loop in which the flushing device, in particular the quantity and/or temperature of the coolant flow, is controlled as a function of the current temperature in the cooling section and a target temperature.

The storage container of the cryogenic storage device according to the invention is closed by the lid section. Preferably, the lid section is provided with a closable lid aperture which is smaller than the lid section. The provision of the lid aperture, which is provided for example with a flap or a sliding panel, makes it possible to remove samples from or introduce samples into the storage container without opening the entire lid section. The coolant consumption in the storage container is thus advantageously minimized. In order to improve the cooling effect of the flushing device, the lid aperture and the cooling section in the hood space are preferably arranged directly adjoining one another. This embodiment of the invention decreases the action of foreign gases on samples during transport between the interior of the storage container and the hood space, and improves the continuous cooling of the samples even during transport.

Further advantages for automation of the cryogenic storage device according to the invention are obtained if the latter is provided with a first transfer device for transferring samples between the inner space of the storage container and the cooling section in the hood space and/or with a second transfer device for transferring samples between the cooling section in the hood space and a surrounding area of the hood device. Advantageously, the drives of the first and/or second transfer device may be arranged in the hood space at a distance from the cooling section. Disadvantageous effects of low temperatures on the drives are advantageously avoided, and the reliability of sample transport is improved. Particular preference is given to a variant in which the second transfer device comprises a transport container which is adapted for holding samples and can be cooled by the flushing device in the cooling section. Samples may be arranged and cooled in the cooling section directly in the transport container before then being transported into the inner space of the storage container or into the external surrounding area of the hood device.

According to a further advantageous embodiment of the invention, the cryogenic storage device may be provided with a cleaning device which is adapted for removing condensate from surfaces in the cooling section, in particular from sample surfaces. The cleaning device acts mechanically and/or thermally on the surface to be cleaned, in order to remove the condensate by a mechanical action, for example by an oscillating brush, and/or a thermal action, for example brief local heating. The provision of the cleaning device has the advantage of removing undesired deposits from surfaces, in particular from the samples, in the event of possible malfunctions of the flushing device or in the event of incomplete shielding of the sample in the cooling section from ambient gases.

The cryogenic storage device according to the invention advantageously permits automated operation with a reliability that is increased in comparison to conventional techniques. Since numerous components are arranged and operated in the sub-area of the hood space that is not cooled or is only slightly cooled, the susceptibility of the cryogenic storage device to faults is reduced. Preferably, a control device is provided by which the flushing device, in particular using said control loop, the lid aperture, the first transfer device, the second transfer device and/or the cleaning device can be controlled. The control device can actuate said components in accordance with a program that depends on the preservation task.

Further details and advantages of the invention will be described below with reference to the appended drawings, which show in:

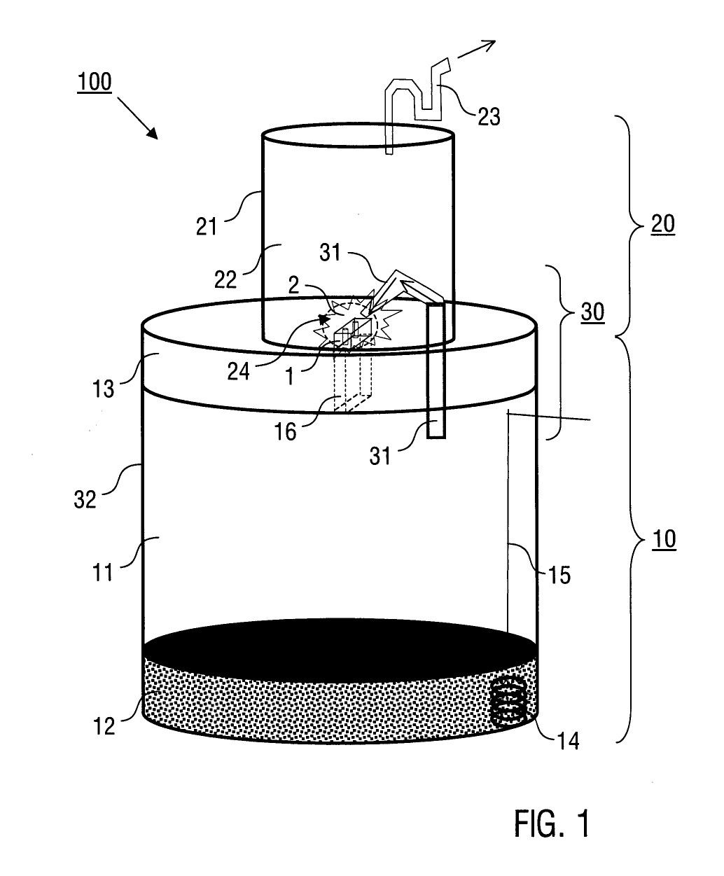

FIGS. 1 to 4: schematic perspective views of preferred embodiments of the cryogenic storage devices according to the invention;

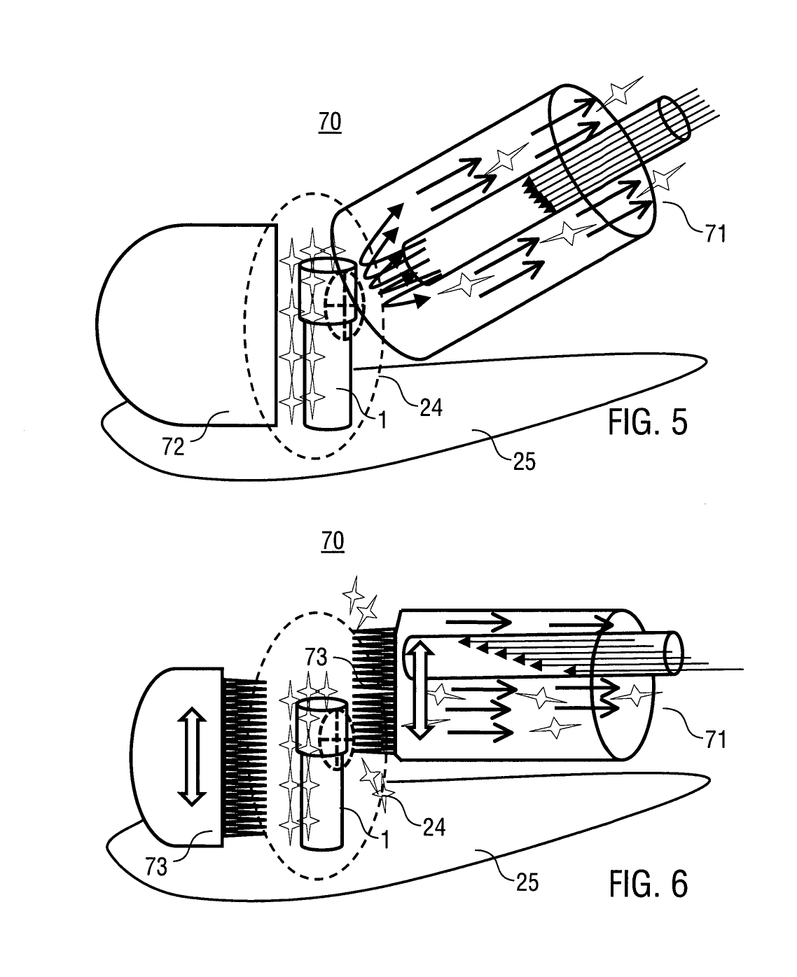

FIGS. 5 and 6: schematic illustrations of cleaning devices, with which the cryogenic storage device according to the invention may be provided;

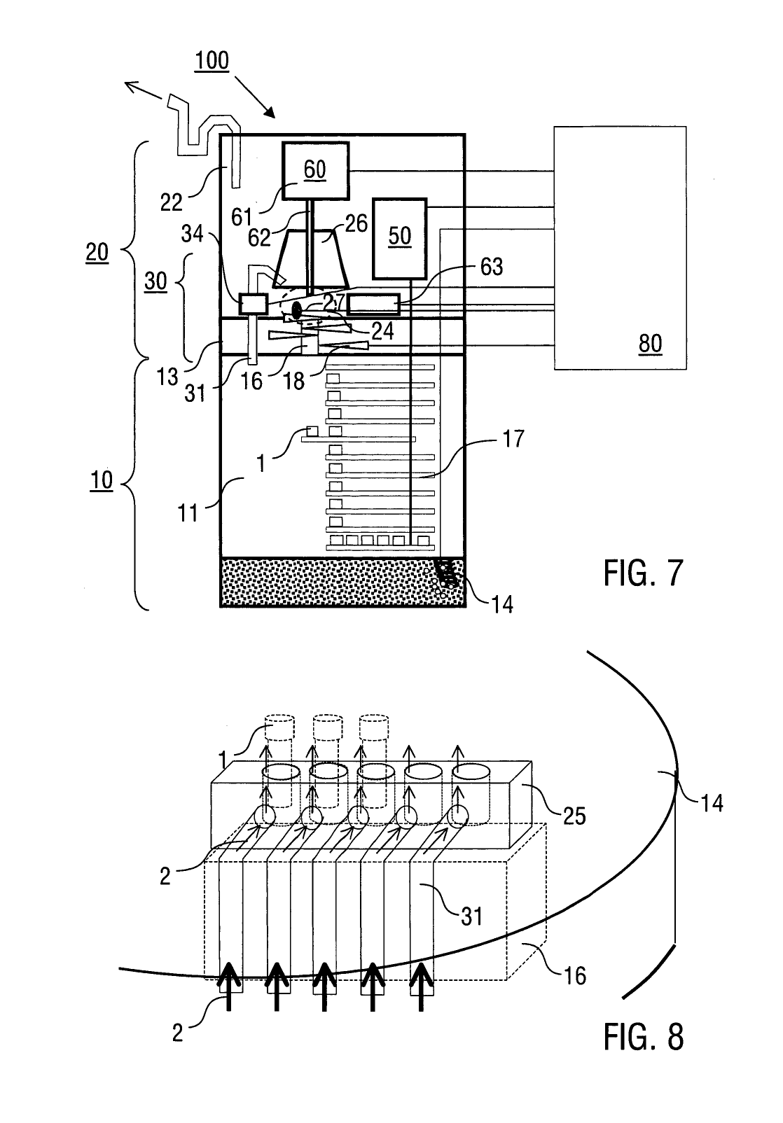

FIG. 7: a schematic side view of a further embodiment of the cryogenic storage device according to the invention with a control device; and

FIG. 8: a schematic illustration of further details of the lid section of a cryogenic storage device according to the invention.

Embodiments of the invention will be described below with reference by way of example in particular to the flushing device and the operation thereof. Details regarding the cryopreservation of samples, in particular regarding sample preparation and the design and operation of a cryotank, will not be described insofar as these are known from conventional techniques.

FIG. 1 shows a first embodiment of the cryogenic storage device 100 according to the invention comprising the storage container 10, the hood device 20 and the flushing device 30, which is shown here for illustration purposes in a perspective ghosted view.

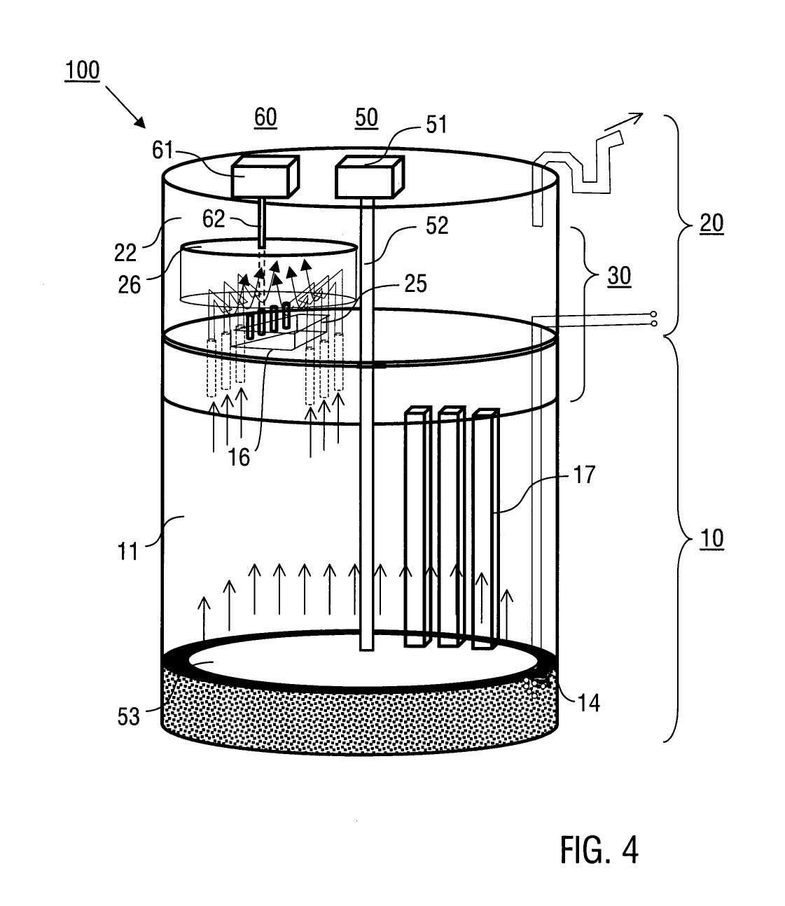

The storage container 10 is a cryotank (Dewar flask) having an inner space 11 which is closed laterally and towards the bottom by a peripheral container wall and which is closed at the top by a lid section 13. The lid section 13 has a closable lid aperture 16, through which a schematically shown sample 1 can be transferred from the inner space 11 into the adjacent hood device 20. Located at the bottom of the inner space 11 is a reservoir 12 of liquid nitrogen at a temperature of, for example, approximately −200° C. Above the reservoir 12, the inner space 11 is filled with nitrogen vapor, in which a temperature of, for example, −150° C. is obtained. The temperature in the nitrogen vapor is the storage temperature in the storage container 10. For storing cryopreserved samples, carrier devices (not shown, see FIGS. 4 and 7) in the form of racks which carry a plurality of biological samples are located in the inner space 11, typically above the reservoir 12 of liquid nitrogen.

The storage container 10 is shown only schematically in FIG. 1. In the practical configuration of a cryotank, said storage container is additionally provided with conduits for supplying liquid nitrogen and optionally for discharging excess nitrogen vapor. The storage container 10 is also provided with a heating device 14, which comprises a resistance heater arranged in the reservoir 12 of liquid nitrogen. The heating device 14 is connected via electrical connection leads 15 to an external power source (not shown) and optionally to a control device (see FIG. 7).

The hood device 20 comprises a hood 21 which is, for example, cylindrical or cube-shaped and which is placed onto the top of the lid section 13 so that the lid aperture 16 is covered by the hood. The hood 21 encloses a hood space 22 which is predominantly filled with ambient air or nitrogen. Excess gas can be led out from the hood space 22 for example via an optionally provided siphon 23. By virtue of the flowing-off via the siphon 23, contamination of the hood space 22 by inflowing air from outside is avoided.

The flushing device 30 comprises a coolant vessel 32, which in the illustrated embodiment is formed by the storage container 10 comprising the reservoir 12 of liquid nitrogen. The flushing device 30 also has a coolant conduit 31 which leads from the coolant vessel 32 (storage container 10), through the lid section 13, into the hood space 22. The inner end of the coolant conduit 31 opens in the inner space 11 of the storage container 10 above the reservoir 12 of liquid nitrogen, while the outer end of the coolant conduit 31 is directed towards a cooling section 24 (encircled in dashed line) in the hood space 22. The coolant conduit 31 is oriented in such a way that a coolant flow of cold nitrogen is flushed directly over the sample 1 in the cooling section 24. The cooling section 24 is thus created, in which the storage temperature which is given in the inner space 11 of the storage container 10 is provided in a locally delimited manner also in the hood space 22. This makes it possible for the sample 1 to be subject to the same cryopreservation conditions in the cooling section 24 as in the inner space 11 of the storage container 10.

In order to apply the method according to the invention, for example in order to transfer a sample 1 from the inner space 11 into the area surrounding the cryogenic storage device 100, the sample 1 is transported by a first transfer device (not shown, see for example FIGS. 4 and 7) through the lid aperture 16 of the lid section 13 into the cooling section 24. Since the same nitrogen gas phase as in the inner space 11 is created in the cooling section 24 via the coolant conduit 31, the preservation conditions for the sample 1 in the cooling section 24 are unchanged in comparison to the inner space. From the cooling section 24, the sample 1 can then be moved to the exterior by a second transfer device (not shown, see for example FIGS. 4 and 7), for example through an access aperture in the wall of the hood 21 or while the hood 21 is temporarily raised.

The supply of nitrogen vapor as coolant through the coolant conduit 31 takes place by the continuous conversion of liquid nitrogen into nitrogen in vapor form in the inner space 11. Since the storage container 10 is tightly closed by the lid section 13, all the nitrogen vapor flows through the coolant conduit 31. If the coolant flow is too low to maintain the desired storage temperature at the sample carrier 25, the coolant flow can be increased by actuating the heating device 14.

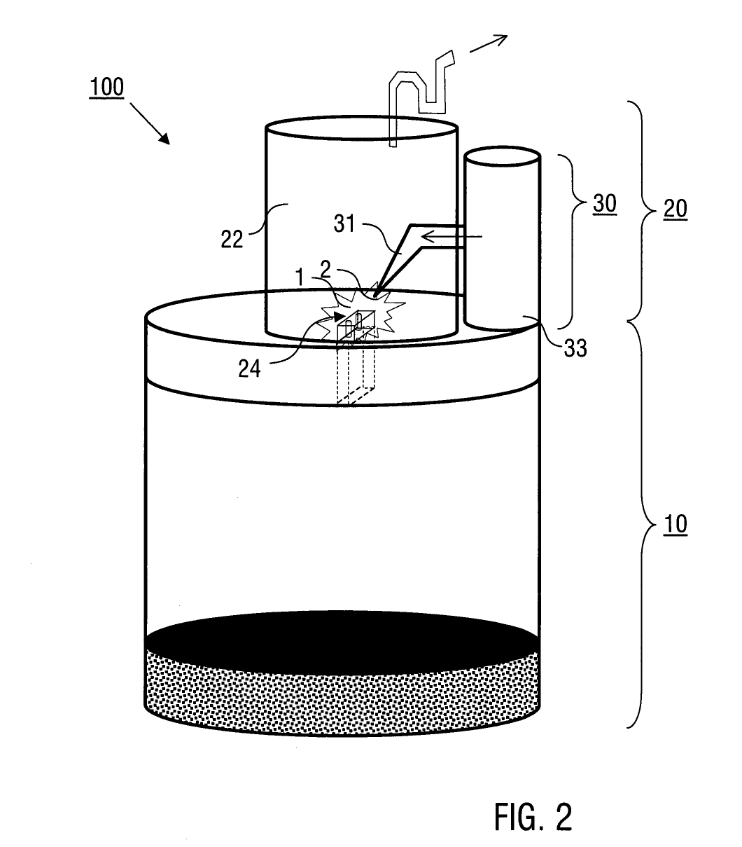

FIG. 2 schematically illustrates a modified embodiment of the cryogenic storage device 100 according to the invention comprising the storage container 10, the hood device 20 and the flushing device 30. In a manner differing from the embodiment shown in FIG. 1, the flushing device 30 comprises as the coolant vessel a separate additional vessel 33, for example in the form of a Dewar flask, for accommodating liquid nitrogen. From the additional vessel 33, a coolant conduit 31 extends into the hood space 22 to the cooling section 24, which is formed by the flowing-in of vapor of cold nitrogen. The coolant flow through the coolant conduit 31 can be controlled, as in the embodiment shown in FIG. 1, by a heating device in the additional vessel 33 (not shown).

The additional vessel 33 may alternatively be a reservoir of anhydrous gas, which on the way through the coolant conduit 31 is thermoelectrically cooled to the desired storage temperature. According to a further variant, the coolant vessel 32 may be provided by a further, adjacent storage container which is of the same size and shape as the storage container 10. By way of example, in a cryobank comprising a plurality of storage containers 10, one of the storage containers may be used by all of the other storage containers as an additional vessel 33 for the flushing device.

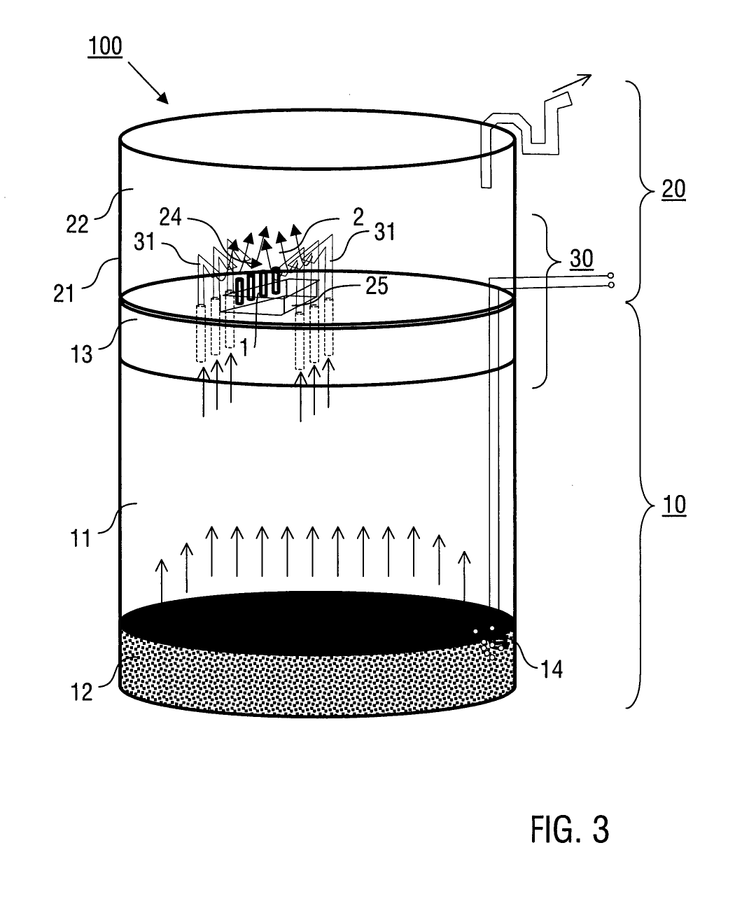

FIG. 3 illustrates a further modified embodiment of the cryogenic storage device 100 according to the invention, in which there is arranged, in a manner differing from FIGS. 1 and 2, not a single coolant conduit but rather a plurality of coolant conduits 31, which extend between the inner space 11 of the storage container 10 and the hood space 22 of the hood device 20. The outer ends of the coolant conduits 31 are directed towards the cooling section 24 above the lid section 13. Samples 1, which are optionally arranged on a sample carrier 25 (see FIG. 8), are flushed with the vapor 2 of cold nitrogen exiting from the coolant conduits 31 in the cooling section 24. The nitrogen then distributes in the hood space 22, during which it heats up, so that an increased temperature prevails outside of the cooling section 24.

Also in a manner differing from FIGS. 1 and 2, FIG. 3 shows that the hood device 20 may be provided with a hood 21 having a diameter equal to that of the storage container 10. A larger volume of the hood space 22 is thus advantageously provided, which can accordingly accommodate more components for sample handling, such as, for example, drives for transfer devices.

The cryogenic storage device 100 shown in FIG. 3 can operate in a completely passive manner. This means that the heating device 14 is not provided or is not actuated. The coolant flow necessary to set the storage temperature at the sample carrier 25 is in this case generated exclusively by the evaporation of nitrogen from the reservoir 12 of liquid nitrogen. If an increased coolant flow is required, it is possible to change over to active cooling of the cooling section 24 by actuating the heating device 14.

The coolant conduits 31 are arranged in a manner evenly distributed around the sample carrier 25 in order to achieve flushing of the samples 1 on the sample carrier 25 on all sides in as uniform a manner as possible. Since the coolant (cold nitrogen gas) is colder than the surrounding atmosphere in the hood space 22, the ends of the coolant conduits 31 are preferably arranged above the samples 1 on the sample carrier 25, so that the coolant flow falls onto the samples 1 from above. Alternatively, however, the coolant flow may also be directed onto the samples 1 from below and/or from the side.

If no removal or insertion of a sample 1 takes place in an operating phase of the cryogenic storage device 100, nitrogen gas can flow continuously into the hood space 22. To this end, the closable lid aperture 16 can remain open, so that the evaporating nitrogen gas flows out of the storage container 10 through the lid aperture 16 and the coolant conduits 31 into the hood space 22. This advantageously means that the hood space 22 is not filled with ambient air but rather with dry nitrogen gas. As a result, ice accumulation on the storage container 10 and the sample 1 is ruled out. Furthermore, the exiting gas heats up in the hood device 20, so that any condensate deposits (frost) between individual sample removals are broken down.

FIG. 4 shows a further modified embodiment of the cryogenic storage device 100 according to the invention, in which a first transfer device 50 for transferring samples between the inner space of the storage container 10 and the sample carrier 25 in the hood space 22 and a second transfer device 60 for transferring samples between the sample carrier 25 and an area surrounding the cryogenic storage device 100 are provided. The first transfer device 50 comprises a first drive 51, which is arranged in the hood space 22 or outside of the hood device 20 and is coupled via a shaft 52 to a platform 53 in the inner space 11. The carrier devices (racks) 17 comprising a plurality of cryosamples are arranged on the platform 53. By actuating the first drive 51, a selected rack 17 can be moved below the lid aperture 16 in order to transfer one or more samples to the sample carrier 25. To this end, for example, the selected rack 17 can be pulled through the lid aperture 16 at least partially into the hood space 22.

The second transfer device 60 serves for moving, removing, inserting or further handling, for example contacting or identifying, the samples 1 on the sample carrier 25. The second transfer device 60 is provided with a second drive 61 and a manipulation arm 62, by which the samples 1 can for example be removed from the sample carrier 25 and transferred into a transport container (not shown). The manipulation arm 62 is provided with a shielding device 26 in the form of a protective cap. The shielding device 26 prevents falling, cooling gases in the hood space 22 from dropping onto the sample 1. The shielding device 26 may comprise, for example, a flat plate (as shown), a downwardly open curved plate or a downwardly open beaker. Alternatively, the shielding device 26 may be composed of a plurality of individual, overlapping elements. According to a further variant, the shielding device may comprise a bellows which is compressed or extended depending on the operating state of the second transfer device 60, in order to shield the cooling section 24 from falling, cooling gases.

The cryogenic storage device 100 according to the invention may be provided with a cleaning device 70 which is arranged next to the sample carrier 25 in the hood space and is adapted for removing condensate (frost, ice crystals), thermally (FIG. 5) and/or mechanically (FIG. 6), from sample surfaces in the cooling section 24. Advantageously, undesired condensate which has deposited onto the sample 1 from an uncooled region of the hood space can be removed by the cleaning device 70. The condensate is shown schematically as stars in FIGS. 5 and 6.

In FIG. 5, a thermal cleaning of the surface of the sample 1 is provided. To this end, the cleaning device 70 comprises a coaxial double pipe 71, the inner pipe of which is connected to a source of dry gas and the outer pipe of which is connected to a suction device (not shown). The source of dry gas provides a dry gas flow at room temperature or at reduced temperature, down as far as the storage temperature, under the effect of which the condensate 3 is removed from the surface by sublimation or by brief, pulsed heating and evaporation, and is conveyed away with the gas flow in the outer pipe. If necessary, a gas reflector 72 may be arranged on the side of the sample 1 located opposite the double pipe 71, by which gas reflector the gas flow is reflected onto the sample after passing the latter. The gas reflector 72 thus aids the cleaning of the surface (de-icing) on all sides of the sample 1.

The mechanically acting cleaning device 70 shown in FIG. 6 likewise comprises a coaxial double pipe 71, through the inner pipe of which dry gas is supplied to the surface of the sample 1 and through the outer pipe of which gas is conveyed away with condensate components. In this case, a cleaning tool 73, such as, for example, a brush, is additionally arranged at the free end of the double pipe 71. By a movement, for example an oscillating movement, transverse to the longitudinal extent of the double pipe 71, the condensate can be scratched off the surface of the sample 1 by the cleaning tool 73. As an alternative or in addition, the cleaning device 70 may have an exclusively mechanical action, as illustrated schematically in the left-hand part of FIG. 6. In this case, a cleaning tool 73 is arranged adjacent to the sample 1 and can be actuated for example by an oscillating drive (not shown) to clean the surface of the sample 1.

FIG. 7 illustrates an embodiment of the invention in which the cryogenic storage device 100 is provided with a control device 80. The control device 80 is adapted for executing different programs for handling samples in the cryogenic storage device 100, such as, for example, the insertion of samples into the storage container 10, the storing of the samples, the removal of samples from the storage container 10 and/or the inventory of samples. To this end, the control device 80 is coupled to the schematically illustrated components of the cryogenic storage device 100 that will be explained below.

As has been described above, the cryogenic storage device 100 comprises the storage container 10, the hood device 20 and the flushing device 30. The carrier devices 17 with samples 1 are arranged in the interior 11 of the storage container 10. By way of the first transfer device 50, samples can be moved through the lid aperture 16 of the lid section 13 into the locally delimited cooling section 24 (encircled in dashed line) in the hood space 22. The lid aperture 16 comprises one or more locks 18 which can be actuated electromechanically by the control device 80. The flushing device 30 comprises as the coolant vessel the storage container 10 and the coolant conduit 31, which is provided with an actuator 34 for controlling the coolant flow through the coolant conduit 31. The actuator 34 is likewise coupled to the control device 80. The cooling section 24 is provided with a temperature sensor 27, by which the local temperature in the cooling section 24 can be measured. The temperature sensor 27 is coupled to the control device 80. The control device 80 is also connected to the heating device 14 in order, when necessary, to increase the generation of cold nitrogen gas in the interior 11 of the storage container 10.

The second transfer device 60 is arranged in the hood device 20 and, as has been explained above with reference to FIG. 4, is equipped with a manipulation arm 62 and a shielding device 26. The drive 61 of the second transfer device 60 also permits actuation of a transport container 63 for holding samples and for transferring the samples into the area surrounding the cryogenic storage device 100. The first transfer device 50 and the second transfer device 60 are likewise coupled to the control device 80.

Said components are actuated by the control device 80 as a function of a stored insertion, storage, removal and/or inventory program. For sample insertion, for example, a sample is transferred into the cooling section 24 by the transport container 63. Depending on the pre-treatment of the sample, the latter is already at the storage temperature or it is cooled to the storage temperature in the cooling section 24. During this, a cleaning of condensate from the sample by the cleaning device 70 according to one of the variants shown in FIGS. 5 and 6 may be provided. If the cooling capacity of the flushing device 30 is too low, for example when freezing the sample, this is detected by the temperature sensor 27, whereupon the heating device 14 is actuated by the control device 80 to increase the coolant flow through the coolant conduit 31. Once the sample has been provided, said sample can be inserted into the storage container 10 according to an insertion program. To this end, the locks 18 of the lid aperture 16 are opened and the sample is transferred into the carrier device 17 in the interior 11 of the storage container 10 by the first transfer device 50. The removal of a sample takes place in the opposite manner by transferring the sample through the lid aperture 16 to the cooling section 24 by way of the first transfer device 50. While maintaining the storage temperature, for example −150° C., the sample is transferred by the second transfer device 60 into the transport container 63 and is transferred for example for further use into the area surrounding the cryogenic storage device 100.

Further details regarding the lid section 13 of the cryogenic storage device are illustrated in FIG. 8. Provided in the lid section 13 is a lid aperture 16, on top of which a sample carrier 25 is arranged. The sample carrier 25 comprises, for example, a holder for a plurality of samples (cryotubes). In addition, coolant conduits 31 are guided through the lid aperture 16, each coolant conduit 31 opening into one of the holders of the sample carrier 25. To this end, the holders in the sample carrier 25 have lateral openings, at which the coolant conduits 31 end. Through the coolant conduits 31, a coolant flow 2 of cold nitrogen gas is flushed out of the storage container to the samples 1, so that the latter are kept at the storage temperature in the sample carrier 25 and remain free of ice. Preferably, the sample carrier 25 is made of a material having high thermal conductivity and/or heat capacity, such as, for example, aluminum, silver, copper, soapstone or ceramic. The temperature in the immediate vicinity of the samples is detected by temperature sensors (not shown) in order to be able to adjust the coolant flow through the coolant conduits 31.

The features presented in the claims, the description and the drawings may be important, individually or in combination, for implementing the invention in its various embodiments.

1. A cryogenic storage device which is adapted for storing biological samples in a cryopreserved state, comprising
a storage container which has an inner space for accommodating and for cooling the samples at a predetermined storage temperature in a reservoir of liquid nitrogen or in a nitrogen vapor above the reservoir of liquid nitrogen, the inner space being closed by a lid section,
a hood device having a hood which encloses a hood space adjoining the lid section, and
a flushing device which has a coolant vessel and which is provided for introducing a coolant into the hood space,
wherein
the flushing device has at least one coolant conduit which opens into the hood space and is provided for flushing a locally delimited cooling section with a coolant flow and for setting the storage temperature in the cooling section.

2. The cryogenic storage device according to claim 1, wherein the coolant vessel includes at least one of the features
the coolant vessel is adapted for accommodating liquid nitrogen and comprises at least one of the storage container and an additional container for accommodating liquid nitrogen outside of the storage container, and
the coolant vessel is provided with a thermoelectric cooling device for cooling the coolant.

3. The cryogenic storage device according to claim 2, wherein
a heating device is arranged in the at least one of the storage container and the additional container, said heating device being adapted for generating the coolant flow from nitrogen vapor.

4. The cryogenic storage device according to claim 2, wherein
the coolant vessel comprises the storage container, and
the at least one coolant conduit extends from the inner space of the storage container through the lid section to the cooling section.

5. The cryogenic storage device according to claim 1, wherein the flushing device includes at least one of the features:
a temperature sensor by which the temperature in the cooling section can be measured,
a shielding device by which the cooling section can be shielded against falling gases in the hood space, and
a deflecting device by which the coolant flow from the coolant conduit can be directed into the cooling section.

6. The cryogenic storage device according to claim 1, which further comprises:
a sample carrier which is provided for temporarily holding samples in the cooling section, wherein
the sample carrier is connected to the inner space of the storage container via heat-conducting elements.

7. The cryogenic storage device according to claim 1, wherein
the lid section has a closable lid aperture adjoining the cooling section.

8. The cryogenic storage device according to claim 1, which further comprises at least one of
a first transfer device which is adapted for transferring samples between the inner space and the cooling section, and
a second transfer device which is adapted for transferring samples between the cooling section and a surrounding area of the hood device.

9. The cryogenic storage device according to claim 8, which comprises
the second transfer device, wherein the second transfer device comprises a transport container which can be cooled by the flushing device in the cooling section.

10. The cryogenic storage device according to claim 1, which further comprises
a cleaning device which is adapted for removing condensate from sample surfaces by at least one of a mechanical action and a thermal action.

11. The cryogenic storage device according to claim 7, which comprises
a control device which is adapted for controlling at least one of the flushing device, the closable lid aperture, a first transfer device, which is adapted for transferring samples between the inner space and the cooling section, a second transfer device, which is adapted for transferring samples between the cooling section and a surrounding area hood device and a cleaning device, which is adapted for removing condensate from sample surfaces by at least one of a mechanical action and a thermal action.

12. The cryogenic storage device according to claim 1, wherein
the cooling section has at least one of the features:
the cooling section has a volume that is smaller than the volume of the hood space, and
the cooling section is adapted for temporary sample placement.

13. A method for handling samples in a cryopreserved state, using a cryogenic storage device comprising a storage container which has an inner space for accommodating the samples and for cooling the samples at a predetermined storage temperature in a reservoir of liquid nitrogen or in a nitrogen vapor above the reservoir of liquid nitrogen and which has a lid section, a hood device which forms a hood space adjoining the lid section, and a flushing device which has a coolant vessel that is provided for introducing a coolant flow into the hood space, wherein
the flushing device has at least one coolant conduit which opens into the hood space,
a locally delimited cooling section is cooled by a coolant flow which flows via the at least one coolant conduit to the cooling section, and
the sample, after being removed from the inner space of the storage container or prior to being introduced into the inner space of the storage container, are arranged in the cooling section at the storage temperature while the temperature of the rest of the hood space is increased relative to the cooling section.

14. The method according to claim 13, wherein
the samples in the cooling section are cooled by at least one of vapor of liquid nitrogen from at least one of the storage container and an additional container and a thermoelectrically temperature-controlled coolant.

15. The method according to claim 14, wherein
the coolant flow of the vapor of liquid nitrogen is adjusted by a heating device in at least one of the storage container and in the additional container.

16. The method according to claim 13, wherein
there is arranged in the cooling section a sample carrier which is additionally cooled via heat-conducting elements that are connected to the inner space of the storage container.

17. The method according to claim 13, wherein
the temperature in the cooling section is measured by a temperature sensor and is adjusted by a control loop.

18. The method according to claim 13, wherein
condensate is removed from sample surfaces by at least one of a mechanically acting cleaning device and a thermally acting cleaning device.
